(19) United States
(12) Patent Application Publication
(10) Pub. No.: US 2015/0367749 A1
(43) Pub. Date: Dec. 24, 2015

(54) CONTROL DEVICE FOR VEHICLE

(71) Applicant: Hideaki YAGUCHI, (US)

(72) Inventor: Hideaki YAGUCHI, Toyota-shi (JP)

(73) Assignee: TOYOTA JIDOSHA KABUSHIKI KAISHA, Toyota-shi, Aichi-ken (JP)

(21) Appl. No.: 14/764,693

(22) PCT Filed: Feb. 4, 2014
(86) PCT No.: PCT/IB2014/000192

§ 371 Date: Jul. 30, 2015

(30) Foreign Application Priority Data
Feb. 5, 2013 (JP) 2013-020745

(51) Int. Cl. B60L 15/06

(52) U.S. Cl. CPC B60L 15/06

(57) ABSTRACT

A control device for a vehicle including: a motor; a transmission provided in a path that transmits drive power between the motor and a driving wheel; an inverter configured to drive the motor; a controller configured to control the inverter by using a plurality of control modes including a sinusoidal wave mode to thereby drive the motor, the controller configured to select the control mode in accordance with a gear position of the transmission, the controller configured to select the gear position by which the sinusoidal wave mode is selected when the motor controlled by the controller suppresses a vibration of the vehicle.

### BACKGROUND OF THE INVENTION

1. Field of the Invention

The invention relates to a technology for improving controllability of a motor functioning as a driving force source in a vehicle configured to include the motor.

2. Description of Related Art

There is available a vehicle that includes a motor and a transmission provided in a power transmission path between the motor and driving wheels. Examples of the vehicle include vehicles described in Japanese Patent Application Publication No. 2000-236601 (JP 2000-236601 A) and Japanese Patent Application Publication No. 2004-28280 (JP 2004-28280 A). The vehicle in JP 2000-236601 A is configured to include an engine 2, a motor 4, a clutch 3 provided in a power transmission path between the engine 2 and the motor 4, and a continuously variable transmission 5 provided in the power transmission path between the motor 4 and driving wheels 8. The vehicle in JP 2004-28280 A is configured to include an engine 2, a motor generator 3, and a power drive unit 7 functioning as an inverter. In addition, JP 2000-236601 A discloses a technology for controlling a vehicle speed, a target driving torque, and the speed ratio of the transmission in consideration of the efficiency of the motor during EV running in which the vehicle runs using the motor, and JP 2004-28280 A discloses a technology for controlling the speed ratio of the transmission in consideration of the efficiency of the motor, the friction of the engine, and the transmission efficiency of the transmission. Further, Japanese Patent Application Publication No. 2000-115911 (JP 2000-115911 A) discloses a technology for performing a vibration damping control using the motor, in a case where a vibration becomes likely to occur in the vehicle due to engine start or the like.

### SUMMARY OF THE INVENTION

The output of the vehicle during the EV running is determined by combination of a motor torque and the speed ratio of the transmission. Accordingly, there are a plurality of the combinations of the motor torque and the transmission that can be selected for obtaining the same vehicle output. In addition, there are cases where the control mode of the inverter differs depending on the combination. On the, other hand, in a case where the vibration damping control using the motor is performed, high responsiveness of the motor torque is required for speedily outputting a torque that cancels out a torque fluctuation. Consequently, it is necessary to have the control mode of the inverter having high responsiveness of the motor torque. However, the conventional arts only describe that consideration is given to the efficiency of the motor, and no consideration is given to the control mode of the inverter when the vibration damping control is performed in the conventional arts. As a result, in a case where the vibration damping control is required such as the time of the engine start or the like, the control mode of the inverter having low responsiveness of the motor torque is sometimes selected so that there has been a possibility that a vehicle shock then occurs and drivability is deteriorated.

The invention provides a control device for a vehicle capable of effectively reducing the shock in a running state where the vehicle shock tends to occur such as the time of the engine start or the like in the vehicle configured to include the motor and the transmission.

A first aspect of the present invention provides a control device for vehicle including: a motor; a transmission provided in a path that transmits drive power between the motor and a driving wheel; an inverter configured to drive the motor; a controller configured to control the inverter by using a plurality of control modes including a sinusoidal wave mode to thereby drive the motor, the controller configured to select the control mode in accordance with a gear position of the transmission, the controller configured to select the gear position by which the sinusoidal wave mode is selected when the motor controlled by the controller suppresses a vibration of the vehicle.

With this, when the vibration damping control is performed, the control mode of the inverter is set to the sinusoidal wave mode that provides excellent controllability (responsiveness) of a motor torque. Consequently, the controllability of the motor torque when the vibration damping control is performed is enhanced, and hence a vehicle shock is reduced and drivability is improved.

In addition, a second aspect of the present invention provides a control device for vehicle including: a motor; an internal combustion engine; a transmission provided in a path that transmits drive power between the motor and a driving wheel; an inverter configured to drive the motor; a controller configured to control the inverter by using a plurality of control modes including a sinusoidal wave mode to thereby drive the motor, the controller configured to select the control mode in accordance with a gear position of the transmission, the controller configured to select the gear position by which the sinusoidal wave mode is selected when the internal combustion engine is starting up.

With this, at the time of the engine starting up when a torque fluctuation is increased, the control mode of the inverter is set to the sinusoidal wave mode that provides excellent controllability (responsiveness) of the motor torque. Consequently, the controllability of the motor torque is improved when the engine is starting up, and hence accuracy in vibration damping control during the engine starting up is enhanced, the vehicle shock is reduced, and drivability is improved.

In addition, the control device according to the first aspect of the present invention and the second aspect of the present invention wherein the controller may be configured to select the gear position such that a target gear position that requires the smallest number of gear shifting from a current gear position in case there are at least two gear positions by which sinusoidal wave mode is selected. With this, the number of times of the gear shifting is minimized, and hence a shock during the gear shifting is reduced as compared with a case where the gear position is shifted to the gear position away from the current gear position in terms of the number of times of the gear shifting.

Further, the controller may be configured to select the gear position that maximizes efficiency of the internal combustion engine after the starting up of the internal combustion engine is ended. With this, when the vibration damping control during the engine starting up is ended, the gear position is shifted to the gear position that increases the engine efficiency, and hence fuel efficiency after the engine starting up is improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view for explaining the schematic configuration of a power transmission path from an engine and a motor that constitute a hybrid vehicle to which the invention is preferably applied to driving wheels, and is also a view for explaining the principal portion of a control system provided in the vehicle in order to perform an output control of the engine functioning as a driving force source for running, a gear shifting control of an automatic transmission, and a drive control of the motor;

FIG. 2 is a functional block diagram for explaining the principal portion of a control function by an electronic control device of FIG. 1;

FIG. 3 is a motor efficiency map of the motor of FIG. 1;

FIG. 4 is a control mode map showing application areas of control modes of an inverter;

FIG. 5 is an example of an operation state of the motor when a command for starting the engine is outputted during running in an EV running mode;

FIG. 6 is a flowchart for explaining the principal portion of a control operation of the electronic control device of FIG. 1, i.e., the control operation capable of effectively reducing a vibration by a vibration damping control to thereby improve drivability when the vibration damping control is executed;

FIG. 7 is a functional block diagram for explaining the principal portion of a control operation of an electronic control device as another embodiment of the invention;

FIG. 8 is an example of an engine efficiency map of the engine;

FIG. 9 is a flowchart for explaining the principal portion of a control operation of the electronic control device of FIG. 7, i.e., the control operation capable of improving fuel efficiency when running is switched from EV running to engine running; and

FIG. 10 is a flowchart for explaining still another embodiment of the invention.

### DETAILED DESCRIPTION OF EMBODIMENTS

Hereinbelow, embodiments of the invention will be described in detail with reference to the drawings. Note that figures are simplified or deformed as needed in the following embodiments, and dimensions and shapes of individual portions are not necessarily precisely depicted.

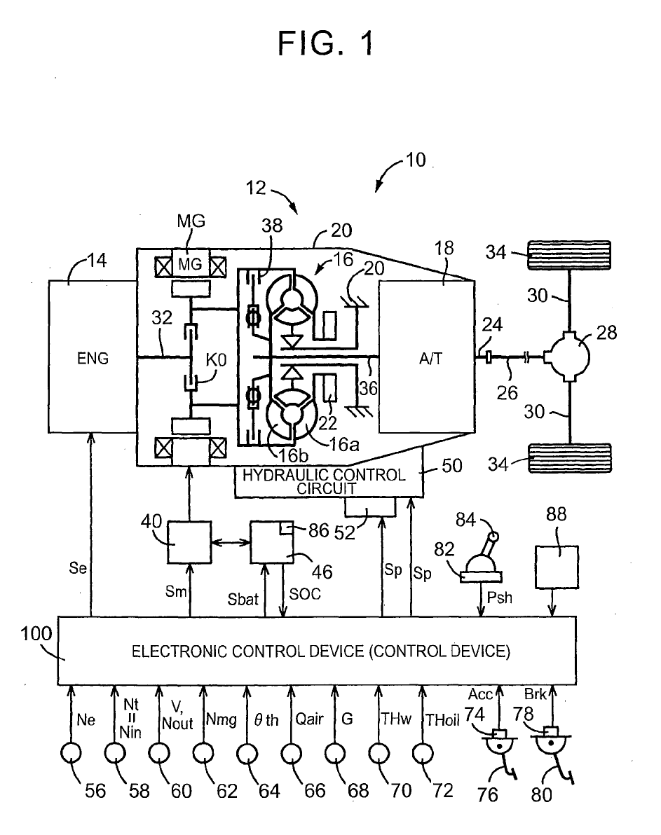

FIG. 1 is a view for explaining the schematic configuration of a power transmission path from an engine 14 and a motor MG that constitute a hybrid vehicle 10 (hereinafter referred to as a vehicle 10) to which the invention is preferably applied to driving wheels 34, and is also a view for explaining the principal portion of a control system provided in the vehicle 10 in order to perform an output control of the engine 14 functioning as a driving force source for running, a gear shifting control of an automatic transmission 18, and a drive control of the motor MG.

In FIG. 1, a vehicle power transmission device 12 (hereinafter referred to as a power transmission device 12) includes an engine disengaging clutch K0, the motor MG, a torque converter 16, an oil pump 22, and the automatic transmission 18 that are arranged in this order from the side of the engine 14 in a transmission case 20 (hereinafter referred to as a case 20) as a non-rotary member attached to a body by bolting or the like. In addition, the power transmission device 12 includes a propeller shaft 26 coupled to an output shaft 24 as an output rotary member of the automatic transmission 18, a differential gear 28 coupled to the propeller shaft 26, and a pair of axles 30 coupled to the differential gear 28. The thus configured power transmission device 12 is suitably used in the vehicle 10 of, e.g., a front-engine rear-drive (FR) type. In the power transmission device 12, in a case where the engine disengaging clutch K0 is engaged, the power of the engine 14 is transmitted from an engine coupling shaft 32 that couples the engine 14 to the engine disengaging clutch K0 to a pair of the driving wheels 34 via the engine disengaging clutch K0, the torque converter 16, the automatic transmission 18, the propeller shaft 26, the differential gear 28 and the pair of axles 30.

The torque converter 16 is a fluid type power transmission device that transmits a driving force inputted to a pump impeller 16a to the side of the automatic transmission 18 via a fluid. The pump impeller 16a is coupled to the engine 14 via the engine disengaging clutch K0 and the engine coupling shaft 32, and is an input side rotary element rotatable about an axis to which the driving force from the engine 14 is inputted. A turbine impeller 16b of the torque converter 16 is an output side rotary element of the torque converter 16, and is coupled to a transmission input shaft 36 as an input rotary member of the automatic transmission 18 by spline fitting or the like so as not to be rotatable relative to each other. In addition, the torque converter 16 includes a lock-up clutch 38. The lock-up clutch 38 is a direct connection clutch provided between the pump impeller 16a and the turbine impeller 16b, and is brought into an engaged state, a slipping state, and a disengaged state by a hydraulic control or the like.

The motor MG is what is called a motor generator having a function as a motor that generates a mechanical driving force from electric energy and a function as a generator that generates the electric energy from mechanical energy. In other words, the motor MG can function as a driving force source for running that generates the driving force for running as a substitute for the engine 14 as a power source or together with the engine 14. In addition, the motor MG generates the electric energy by regeneration from the driving force generated by the engine 14 or a driven force (the mechanical energy) inputted from the side of the driving wheels 34, and stores the electric energy in a battery 46 as a power storage device via an inverter 40 and a step-up converter (not shown). The motor MG is coupled to the pump impeller 16a, and power is transmitted mutually between the motor MG and the pump impeller 16a. Accordingly, similarly to the engine 14, the motor MG is coupled to the transmission input shaft 36 so as to be able to transmit the power. The motor MG is connected via the inverter 40 and the step-up converter (not shown) so as to exchange electric power with the battery 46. In a case where the vehicle runs with the motor MG used as the driving force source for running, the engine disengaging clutch K0 is disengaged, and the power of the motor. MG is transmitted to the pair of the driving wheels 34 via the torque converter 16, the automatic transmission 18, the propeller shaft 26, the differential gear 28, and the pair of the axles 30.

The oil pump 22 is coupled to the pump impeller 16a, and is a mechanical oil pump that generates a hydraulic oil pressure for performing the gear shift control of the automatic transmission 18, controlling the torque capacity of the lock-up clutch 38, controlling the engagement/disengagement of the engine disengaging clutch K0, and supplying lubricant to the individual portions of the power transmission path of the vehicle 10 by being rotationally driven by the engine 14 (or the motor MG). In addition, the power transmission device 12 includes an electric oil pump 52 that is driven by an electric motor (not shown), and complimentarily operates the electric oil pump 52 to generate a hydraulic pressure in a case where the oil pump 22 is not driven such as when the vehicle stops.

The engine disengaging clutch K0 is, e.g., a wet multiple-disk hydraulic frictional engagement device in which a plurality of friction plates stacked on each other are pressed by an hydraulic actuator, and is subjected to an engagement/disengagement control by a hydraulic control circuit 50 provided in the power transmission device 12 by using the hydraulic pressure generated by the oil pump 22 or the electric oil pump 52 as a source pressure. In the engagement/disengagement control, the torque capacity that can be transmitted by the engine disengaging clutch K0, i.e., the engagement force of the engine disengaging clutch K0 is, e.g., continuously changed by a pressure controller such as a linear solenoid valve or the like in the hydraulic control circuit 50. The engine disengaging clutch K0 includes a pair of clutch rotary members (a clutch hub and a clutch drum) that are rotatable relative to each other when the engine disengaging clutch K0 is disengaged. One of the clutch rotary members (the clutch hub) is coupled to the engine coupling shaft 32 so as not to be rotatable relative thereto. The other one of the clutch rotary members (the clutch drum) is coupled to the pump impeller 16a of the torque converter 16 so as not to be rotatable relative thereto. With the configuration described above, when the engine disengaging clutch K0 is engaged, the pump impeller 16a is rotated integrally with the engine 14 via the engine coupling shaft 32. That is, when the engine disengaging clutch K0 is engaged, the driving force from the engine 14 is inputted to the pump impeller 16a. On the other hand, when the engine disengaging clutch K0 is disengaged, the power transmission between the pump impeller 16a and the engine 14 is interrupted. In addition, as described above, since the motor MG is operationally coupled to the pump impeller 16a, the engine disengaging clutch K0 is provided in the power transmission path between the engine 14 and the motor MG and functions as a clutch for connecting or disconnecting the engine 14 to or from the motor MG Further, as the engine disengaging clutch K0 of the present embodiment, a clutch of which the torque capacity (the engagement force) is increased in proportion to the hydraulic pressure, and which is disengaged when the hydraulic pressure is not supplied, i.e., what is called a normally open type clutch is used.

The automatic transmission 18 is coupled to the motor MG so as to be able to transmit the power without the intervention of the engine disengaging clutch K0 to constitute a part of the power transmission path from the engine 14 and the motor MG to the driving wheels 34, and transmits the power from the driving force sources for running (the engine 14 and the motor MG) to the side of the driving wheels 34. The automatic transmission 18 is a planetary gear type multistage transmission that functions as a stepped automatic transmission in which a plurality of gear positions (speed stages) are selectively established. The gear shifting of the automatic transmission 18 is executed by switching between the engagement and the disengagement of any of a plurality of engagements devices, e.g., hydraulic frictional engagement devices such as a clutch C, a brake B, and the like (i.e., the engagement and the disengagement of the hydraulic frictional engagement device). The automatic transmission 18 is a stepped transmission that performs what is called clutch-to-clutch gear shifting, and changes the rotation of the transmission input shaft 36 and outputs the rotation from the output shaft 24. In addition, the transmission input shaft 36 is also a turbine shaft that is rotationally driven by the turbine impeller 16b of the torque converter 16. In the automatic transmission 18, by the engagement/disengagement control of the clutch C and the brake B, a specific gear position (the speed stage) is established according to the accelerator operation by a driver, a vehicle speed V and the like. When the clutch C and the brake B of the automatic transmission 18 are both disengaged, a neutral position state is established, and the power transmission path between the driving wheels 34 and the engine 14 and the motor MG is interrupted. Note that the automatic transmission 18 corresponds to a transmission of the invention provided in the power transmission path between the motor and the driving wheels.

Returning to FIG. 1, in the vehicle 10, there is provided an electronic control device 100 that includes a control device related to, e.g., a hybrid drive control and the like. The electronic control device 100 is configured to include what is called a microcomputer that has, e.g., a central processing unit (CPU), a random access memory (RAM), a read-only memory (ROM), and an input/output interface, and the CPU performs signal processing according to programs pre-stored in the ROM while utilizing the temporary storage function of the RAM to thereby execute various controls of the vehicle 10. For example, the electronic control device 100 executes the output control of the engine 14, the drive control of the motor MG including the regeneration control of the motor MG, the gear shifting control of the automatic transmission 18, the torque capacity control of the lock-up clutch 38, and the torque capacity control of the engine disengaging clutch K0, and is configured to be divided into a portion for the engine control, a portion for the motor control, and a portion for the hydraulic control (the gear shift control) on an as needed basis.

To the electronic control device 100, for example, there are supplied a signal indicative of an engine rotation speed Ne as the rotation speed of the engine 14 detected by an engine rotation speed sensor 56, a signal indicative of a turbine rotation speed Nt of the torque converter 16 as the input rotation speed of the automatic transmission 18 detected by a turbine rotation speed sensor 58, i.e., a transmission input rotation speed Nin as the rotation speed of the transmission input shaft 36, a signal indicative of a transmission output rotation speed Nout as the rotation speed of the output shaft 24 corresponding to the vehicle speed V and the rotation speed of the propeller shaft 26 as vehicle speed related values detected by an output shaft rotation speed sensor 60, a signal indicative of a motor rotation speed Nmg as the rotation speed of the motor MG detected by a motor rotation speed sensor 62, a signal indicative of a throttle valve opening θth as the opening of an electronic throttle valve (not shown) detected by a throttle sensor 64, a signal indicative of an intake air amount Qair of the engine 14 detected by an intake air amount sensor 66, a signal indicative of a longitudinal acceleration G (or a longitudinal deceleration G) of the vehicle 10 detected by an acceleration sensor 68, a signal indicative of a cooling water temperature THw of the engine 14 detected by a cooling water temperature sensor 70, a signal indicative of a hydraulic oil temperature THoil of the hydraulic oil in the hydraulic control circuit 50 detected by an oil temperature sensor 72, a signal indicative of an accelerator depression amount Acc as the operation amount of an accelerator pedal 76 as the requested amount of the driving force (a driver's requested output) to the vehicle 10 by the driver detected by an accelerator depression amount sensor 74, a signal indicative of a brake operation amount Brk as the operation amount of a brake pedal 80 as the requested amount of a braking force (a driver's requested deceleration) to the vehicle 10 by the driver detected by a foot brake sensor 78, a signal indicative of a lever position (a shift operation position, a shift position, an operation position) Psh of a shift lever 84 such as conventional “P”, “N”, “D”, “R”, and “S” positions detected by a shift position sensor 82, and a state of charge (SOC) (a charge capacity, a remaining charge amount) of the battery 46 detected by a battery sensor 86. In addition, electric power from an auxiliary battery 88 charged with electric power of which the voltage is reduced by a direct current-direct current (DC/DC) converter (not shown) is supplied to the electronic control device 100.

In addition, from the electronic control device 100, for example, there are outputted an engine output control command signal Se for the output control of the engine 14, a motor control command signal Sm for controlling the operation of the motor MG, and a hydraulic command signal Sp for operating an electromagnetic valve (a solenoid valve) and the electric oil pump 52 included in the hydraulic, control circuit 50 in order to control the hydraulic actuators of the engine disengaging clutch K0 and the clutch C and the brake B of the automatic transmission 18.

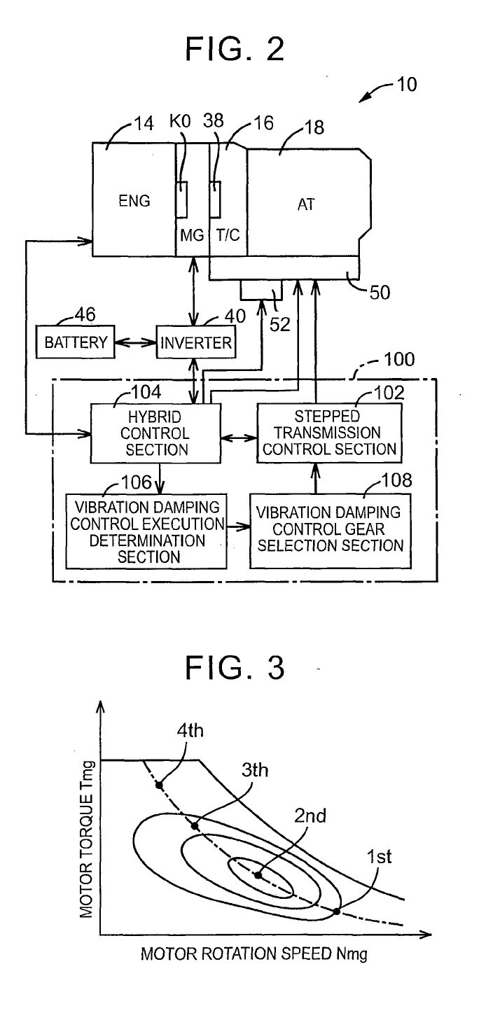

FIG. 2 is a functional block diagram for explaining the principal portion of the control function by the electronic control device 100. In FIG. 2, a stepped transmission control section 102 (stepped transmission control means) function as a gear shifting control section that performs gear shifting of the automatic transmission 18. The stepped transmission control section 102 determines whether or not the gear shifting of the automatic transmission 18 is executed based a vehicle state indicated by the actual vehicle speed V and the actual accelerator depression amount Acc from a pre-stored known relationship (a gear shift diagram, a gear shift map) having an upshift line and a downshift line that uses, e.g., the vehicle speed V and the accelerator depression amount Acc (or a transmission output torque Tout or the like) as variables, i.e., determines the gear position of the automatic transmission 18 to be established by the gear shifting, and executes the automatic gear shifting control of the automatic transmission 18 such that the determined gear position is obtained. For example, in a case where the accelerator depression amount Acc (a vehicle request torque) goes beyond the downshift line toward the side of the high accelerator depression amount (a high vehicle request torque) with an increase in the accelerator depression amount Acc by the depression operation of the accelerator pedal 76, the stepped transmission control section 102 determines that a downshift request of the automatic transmission 18 is made, and executes a downshift control of the automatic transmission 18 corresponding to the downshift line. At this point, the stepped transmission control section 102 outputs a command (a gear shifting output command, a hydraulic command) Sp for engaging and/or disengaging the engagement device related to the gear shifting of the automatic transmission 18 to the hydraulic control circuit 50 such that the gear position is achieved according to, e.g., a pre-stored specific engagement operation table. According to the command Sp, for example, the hydraulic control circuit 50 operates the linear solenoid valve in the hydraulic control circuit 50 to thereby operate the hydraulic actuator of the engagement device related to the gear shifting such that a disengagement-side clutch is disengaged and an engagement-side clutch is engaged so that the gear shifting of the automatic transmission 18 is executed.

A hybrid control section 104 (hybrid control means) has a function as an engine drive control section that controls the drive of the engine 14 and a function as a motor operation control section that controls the operation as the driving force source or the generator by the motor MG via the inverter 40 that controls the motor MG, and executes a hybrid drive control by the engine 14 and the motor MG using the control functions. For example, the hybrid control section 104 calculates the vehicle request torque from the accelerator depression amount Acc and the vehicle speed V, and controls the driving force sources for running such that the output torque of the driving force sources for running (the engine 14 and the motor MG) that achieves the vehicle request torque is obtained in consideration of a transmission loss, an auxiliary load, the gear of the automatic transmission 18, the SOC of the battery 46 and the like.

More specifically, in a case where the above-mentioned vehicle request torque can be supplied only by a motor torque Tmg of the motor MG, the hybrid control section 104 sets a running mode to a motor running mode (hereinafter referred to as an EV running mode), and performs motor running (EV running) that uses the motor MG as the driving force source for running. In a case where the EV running is performed, the hybrid control section 104 disengages the engine disengaging clutch K0 to interrupt the power transmission path between the engine 14 and the torque converter 16, and causes the motor MG to output the motor torque Tmg required for the motor running. At this point, from among the combinations of the operation state of the motor MG (the motor torque Tmg, the motor rotation speed Nmg) and the gear of the automatic transmission 18 with which the requested driving force of the vehicle is obtained during the EV running, the hybrid control section 104 determines the gear position that maximizes the motor efficiency of the motor MG, and outputs the command for shifting the gear position to the determined gear position to the stepped transmission control section 102.

FIG. 3 shows a motor efficiency map of the motor MG in which the horizontal axis indicates the motor rotation speed Nmg, and the vertical axis indicates the motor torque Tmg. In FIG. 3, a one-dot chain line indicates a power curve of the motor MG or the like, and each of four points shown in the power curve indicates the operation state of the motor MG in a case where each gear position is selected by gear shifting at a specific vehicle speed. For example, in the first gear position (1st), the input rotation speed Nin of the automatic transmission 18 is maximized, and hence the motor rotation speed Nmg is maximized, and the motor torque Tmg is minimized. In the second gear position (2nd), the motor rotation speed Nmg becomes lower than that in the first gear position, and the motor torque Tmg becomes larger than that in the first gear position. In the third gear position (3rd), the motor rotation speed Nmg becomes lower than that in the second gear position, and the motor torque Tmg becomes larger than that in the second gear position. In the fourth gear position (4th), the motor rotation speed Nmg is minimized, and the motor torque Tmg is maximized.

Herein, oblongs shown in FIG. 3 indicate contour lines representing the level of the motor efficiency. In FIG. 3, as the oblong indicative of the contour line is smaller, the motor efficiency of the motor MG indicates a higher value. Consequently, in FIG. 3, the motor efficiency of the motor MG is maximized in the second gear position. Accordingly, the hybrid control section 104 outputs the command for shifting the gear position of the automatic transmission 18 to the second gear position to the stepped transmission control section 102. Thus, during the EV running, the hybrid control section 104 determines the gear position that maximizes the motor efficiency of the motor MG in the operation state of the motor MG in each gear position that satisfies the requested driving force of the vehicle from the motor efficiency map of FIG. 3.

On the other hand, in a case where the above-mentioned vehicle request torque cannot be supplied without using at least the output torque (engine torque) Te of the engine 14, the hybrid control section 104 sets the running mode to the engine running mode, and performs the engine running that uses at least the engine 14 as the driving force source for running. When the engine running is performed, the hybrid control section 104 engages the engine disengaging clutch K0 to transmit the driving force from the engine 14 to the pump impeller 16a, and causes the motor MG to output an assist torque on an as needed basis. Note that the hybrid control section 104 prevents the shortage of the hydraulic oil by complimentarily operating the electric oil pump 52 in a case where the oil pump 22 is not driven such as when the vehicle stops.

In addition, in a case where the accelerator pedal 76 is depressed during the EV running so that the vehicle request torque is increased, and the motor torque Tmg required for the EV running corresponding to the increased vehicle request torque exceeds the range of a predetermined EV running torque that allows the EV running, the hybrid control section 104 switches the running mode from the EV running mode to the engine running mode, and performs the engine running by starting the engine 14. When the engine 14 is starting up, while engaging the engine disengaging clutch K0 toward complete engagement, the hybrid control section 104 transmits an engine starting torque Tmgs for starting up the engine to the engine 14 from the motor MG via the engine disengaging clutch K0 to thereby increase the rotation of the engine 14, increases the engine rotation speed Ne to the rotation speed that allows the self operation of the engine, controls an engine ignition and fuel supply, and thereby starts the engine 14. Subsequently, after the starting up of the engine 14, the hybrid control section 104 speedily engages the engine disengaging clutch K0 completely.

Further, during coasting when the accelerator is off or during braking by depression of the brake pedal 80, in order to improve fuel efficiency, the hybrid control section 104 has a function as regeneration control means for rotationally driving the motor MG using kinetic energy of the vehicle 10, i.e., a reverse driving force transmitted from the driving wheels 34 to the side of the engine 14 to cause the motor MG to operate as the generator, and charging the battery 46 with the electric energy via the inverter 40. This regeneration control is performed such that the regeneration amount determined based on the SOC of the battery 46 and the braking force distribution of the braking force by a hydraulic brake for obtaining the braking force corresponding to the operation amount of the brake pedal is achieved. In addition, in the present embodiment, the hybrid control section 104 engages the lock-up clutch 38 during regenerative coasting.

Further, in a running state where a torque fluctuation tends to occur such as the time of the engine starting up, the hybrid control section 104 executes a vibration damping control in which a vibration caused by the torque fluctuation is reduced by outputting a torque in opposite phase (opposite torque) in a direction that cancels out the torque fluctuation from the motor MG When the vibration damping control using the motor MG is executed, high controllability (responsiveness) of the motor torque Tmg is required. Incidentally, the inverter 40 of the motor MG includes a plurality of control modes. Specifically, the inverter 40 of the present embodiments has three control modes of a sinusoidal wave mode (a sinusoidal wave PWM), an overmodulation mode (an overmodulation PWM), and a rectangular wave mode (one pulse). The sinusoidal wave mode is the most commonly used voltage waveform. In the sinusoidal wave mode, an output voltage is converted into a pulse state, and the voltage has the sinusoidal wave by controlling the pulse width so that a torque control having excellent torque responsiveness and high accuracy can be executed. The rectangular wave mode forms an alternating current (AC) waveform with one pulse and, in the rectangular wave mode, responsiveness is low and controllability is lower than that in the sinusoidal wave mode. The overmodulation mode is a mode positioned between the sinusoidal wave mode and the rectangular wave mode, and the level of the controllability in the overmodulation mode is between that in the sinusoidal wave mode and that in the rectangular wave mode. Consequently, when the vibration damping control is executed, the control mode of the inverter 40 is preferably set to the sinusoidal wave mode.

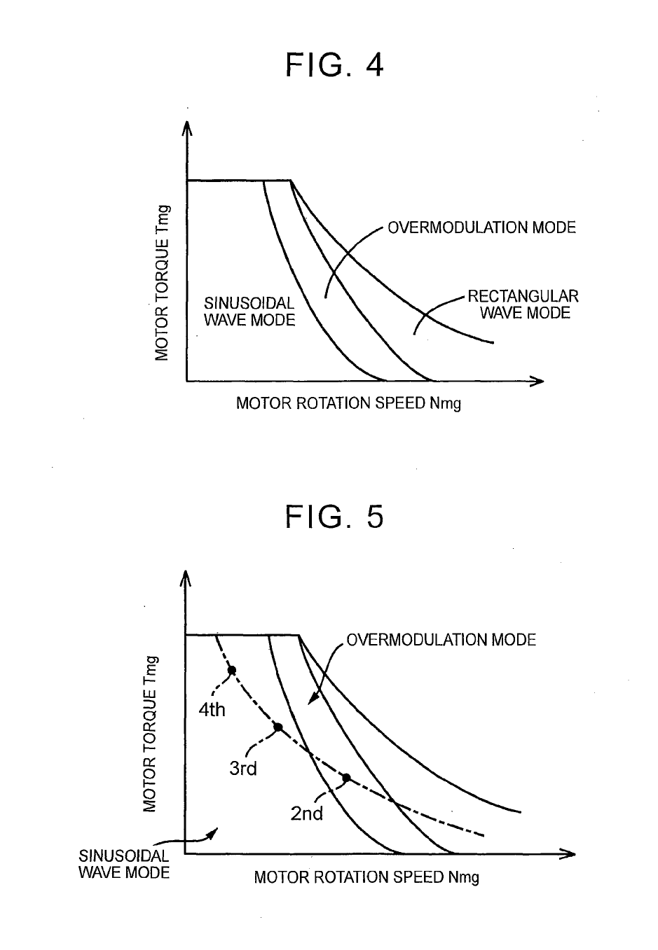

FIG. 4 is a control mode map showing the application areas of the control modes of the inverter 40. In FIG. 4, the horizontal axis indicates the motor rotation speed Nmg, and the vertical axis indicates the motor torque Tmg. As shown in FIG. 4, the sinusoidal mode is used in a low rotation speed area, while the rectangular wave mode is used in a high rotation speed area. The overmodulation mode is used in a rotation speed area between the sinusoidal wave mode and the rectangular wave area. Thus, the control mode of the inverter 40 is changed based on the motor rotation speed Nmg and the motor torque Tmg of the motor MG. Herein, when the above-described vibration damping control is executed, the vibration damping control is preferably executed in the sinusoidal wave mode that is most excellent in the responsiveness (controllability) of the motor torque Tmg. However, since the operation state of the motor MG corresponds to the area of the rectangular wave mode or the overmodulation mode depending on the gear position of the automatic transmission 18, there has been a possibility that it becomes difficult to execute the vibration damping control with high accuracy so that a shock occurs in the vehicle and drivability is deteriorated.

To cope with this, in the case where the vibration damping control is performed such as, e.g., the time of the engine start during the EV running, the electronic control device 100 selects the gear position of the automatic transmission 18 such that the control mode of the inverter 40 is set to the sinusoidal wave mode and performs gear shifting. Hereinbelow, a description will be given of the control when the vibration damping control is executed:

Returning to FIG. 2, a vibration damping control execution determination section 106 (vibration damping control execution determination means) determines whether or not the vibration damping control using the motor MG is executed. For example, when the engine is started or stopped, or when the vehicle enters a vehicle speed range in which roll surge of a tire is caused due to the roundness of the tire, the vibration is increased. To cope with this, the vibration damping control execution determination section 106 determines whether or not the vibration damping control is executed based on, e.g., whether or not the command for executing an engine start/stop control is outputted. In addition, the vibration damping control execution determination section 106 sequentially detects the motor rotation speed Nmg of the motor MG, sequentially calculates a change amount ΔNmg of the motor rotation speed Nmg, and determines whether or not the vibration damping control is executed based on whether or not the calculated change amount ΔNmg exceeds a predetermined threshold value.

When the execution of the vibration damping control is determined by the vibration damping control execution determination section 106, the hybrid control section 104 starts the vibration damping control using the motor MG. Before the execution of the vibration damping control, the operation of a vibration damping control gear selection section 108 (vibration damping control gear selection means) is executed. The vibration damping control gear selection section 108 (hereinafter referred to as a gear selection section 108) selects the gear position of the automatic transmission 18 which is optimum for the vibration damping control before the execution of the vibration damping control. Specifically, the gear selection section 108 selects the gear position that sets the control mode of the inverter 40 to the sinusoidal wave mode.

FIG. 5 show an example of the operation state of the motor MG when the command for starting the engine 14 is outputted during running in, e.g., the EV running mode. As shown in FIG. 5, during the running in the second gear position of the automatic transmission 18, the control mode of the inverter 40 is set to the overmodulation mode. When the vibration damping control is executed in this state, since the responsiveness of the motor torque Tmg is inferior to that in the sinusoidal wave mode, it becomes difficult to execute the vibration damping control with high accuracy. In this case, the gear selection section 108 selects the gear position that sets the control mode of the inverter 40 to the sinusoidal wave mode.

First, the gear selection section 108 determines the control mode of the inverter 40 in the current running state from the current operation state of the motor MG (the motor rotation speed Nmg, the motor torque Tmg) by referring to the control mode map of FIG. 4 that defines the control mode of the inverter 40. Herein, when the control mode is the sinusoidal wave mode, the vibration damping control can be executed with high accuracy. In this case, the gear selection section 108 selects the current gear position.

On the other hand, when the control mode of the inverter 40 is the overmodulation mode or the rectangular wave mode, the accuracy of the vibration damping control is lowered. To cope with this, when the control mode of the inverter 40 is not the sinusoidal wave mode, the gear selection section 108 determines the control mode of the inverter 40 in a case where the gear position in the present running state is shifted to another gear position based on the control mode map shown in FIG. 4.

The gear selection section 108 calculates the operation state (the motor rotation speed Nmg, the motor torque Tmg) of the motor MG in the case where the gear position is shifted to another gear position. Herein, in a case where there is a plurality of the gear positions in the automatic transmission 18, the operation state of the motor MG is calculated for each gear position other than the current gear position. First, a description will be given of a method for calculating the motor torque Tmg of each gear position as a parameter indicative of the operation state of the motor MG A motor torque Tmgi (i=1, 2 . . . ) of each gear position (i) is calculated by the following Expression (1). Note that a numerical subscript i in Expression (1) denotes the number of the gear position. In addition, Tout denotes the driving force (the driving torque) outputted from the output shaft 24 of the automatic transmission 18, and is calculated by referring to the actual accelerator depression amount Acc and the actual vehicle speed V in a pre-set driving force map having, e.g., the accelerator depression amount Acc and the vehicle speed V. Further, γi (i=1, 2 . . . ) denotes the gear ratio of each gear position (i). Based on Expression (1), a motor torque Tmg1 at the time of the first gear position 1st is represented by Tout/γ1, a motor torque Tmg2 at the time of the second gear position 2nd is represented by Tout/γ2, and motor torques at the time of the third and subsequent gear positions are also calculated based on Expression (1).

Tmgi=Tout/γi (1)

Next, a description will be given of a method for calculating the motor rotation speed Nmg of each gear position (i) as another parameter indicative of the operation state of the motor MG. A motor rotation speed Nmgi (i=1, 2 . . . ) of each gear position (i) is calculated by the following Expression (2). Note that a numerical subscript i in Expression (2) denotes the number of the gear position. In addition, V denotes the vehicle speed, r denotes a tire radius, and γdef denotes the differential ratio of the differential gear 28 (a differential device). Based on Expression (2), a motor rotation speed Nmg1 at the time of the first gear position 1st is represented by V/(2π+r)×γdef×γ1, a motor rotation speed Nmg2 at the time of the second gear position 2nd is represented by V/(2π×r)×γdef×γ2, and motor rotation speeds at the time of the third and subsequent gear positions are also calculated based on Expression (2).

Nmgi=V/(2π×r)×γdef×γi (2)

When the gear selection section 108 calculates the operation state of the motor MG in each gear position (i), i.e., the motor torque Tmg and the motor rotation speed Nmg of the motor MG when the gear position is shifted to each gear position (i), the gear selection section 108 then determines the control mode of the inverter 40 when the gear position is shifted to each gear position (i) by referring to the control mode map of the inverter 40 of FIG. 4. Subsequently, the gear selection section 108 selects the gear position that sets the control mode of the inverter 40 to the sinusoidal wave mode. Herein, there are cases where there are a plurality of the gear positions that set the control mode to the sinusoidal wave mode. In such cases, the gear selection section 108 selects the gear position that requires the smallest number of times of gear shifting from the current gear position (the smallest number of times of gear change) from among the gear positions that set the control mode thereof to the sinusoidal wave mode.

The gear selection section 108 outputs a command for shifting the gear position to the selected gear position to the stepped transmission control section 102. Upon reception of the command, the stepped transmission control section 102 executes the gear shifting control to the selected gear position. By shifting the gear position to the selected gear position, the control mode of the inverter 40 is switched to the sinusoidal wave mode. Thereafter, the hybrid control section 104 executes the vibration damping control in the sinusoidal wave mode, and hence the responsiveness of the motor torque Tmg in the vibration damping control is enhanced, the vibration is effectively reduced, and drivability is improved. In addition, when the vibration damping control by the hybrid control section 104 is ended, the stepped transmission control section 102 shifts the gear position to the gear position that optimizes fuel efficiency.

For example, in FIG. 5, during running in the second gear position, when it is determined that the running is switched from the EV running to the engine running (the HV running), or the vibration damping control is executed due to the roll surge of the tire or the like, the gear selection section 108 calculates the current operation state of the motor MG, and detects the control mode of the inverter 40. Herein, since the overmodulation mode is set in the second gear position in the running state of FIG. 5, the operation state of the motor MG in a case where the gear position is shifted to another gear position is calculated, and the control mode of the inverter 40 in another gear position is detected from the calculated operation state of the motor MG by referring to the control mode map of FIG. 4. In FIG. 5, in the third and fourth gear positions, the control mode of the inverter 40 is set to the sinusoidal wave mode. Since the gear selection section 108 selects the gear position that requires the smallest number of times of gear shifting (the smallest number of times of gear change) from the current gear position, the third gear position is selected.

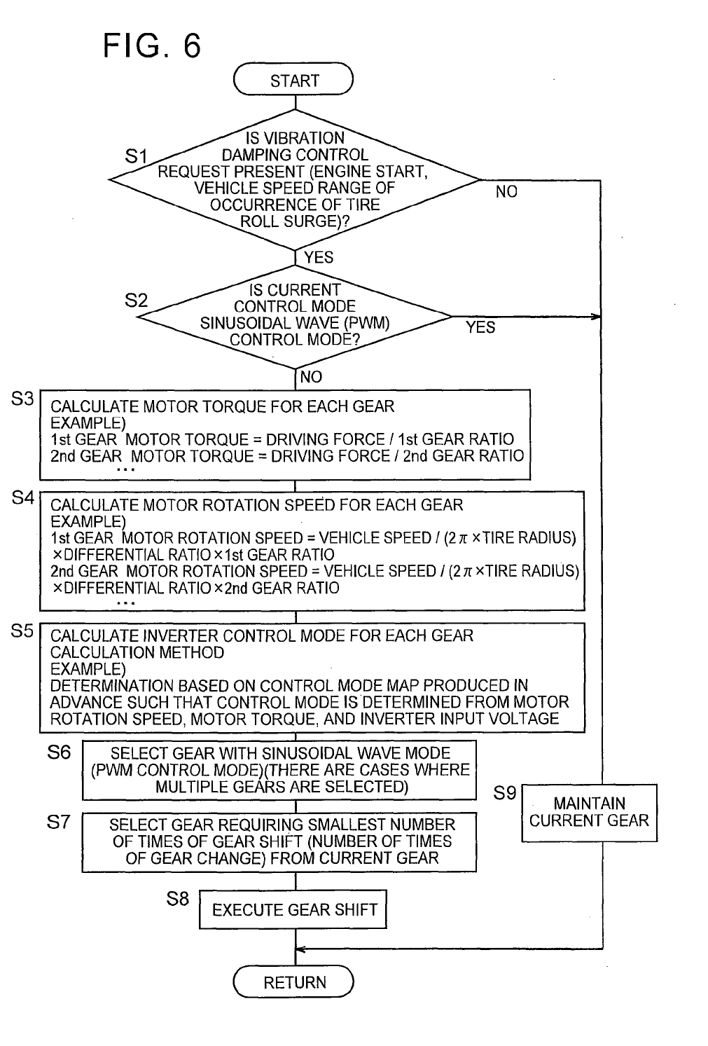

FIG. 6 is a flowchart for explaining the principal portion of the control operation of the electronic control device 100, i.e., the control operation capable of effectively reducing the vibration by the vibration damping control to thereby improve drivability when the vibration damping control is executed, and the control operation is repeatedly executed at an extremely short cycle time of, e.g., about several millisecond to several tens millisecond.

First, in step S1 (hereinafter “step” will be omitted) corresponding to the vibration damping control execution determination section 106, it is determined whether or not the vibration damping control is performed based on the engine starting up and the occurrence of the roll surge. In a case where S1 is negative, in S9 corresponding to the stepped transmission control section 102, the current gear position is maintained, and the present routine is ended. In a case where S1 is affirmative, in S2 corresponding to the gear selection section 108, it is determined whether or not the control mode of the inverter 40 in the current running state is the sinusoidal wave mode. In a case where S2 is affirmative, the current gear position is maintained in S9, and the present routine is ended.

In a case where S2 is negative, in S3 corresponding to the gear selection section 108, the motor torque Tmg of the motor MG in a case where the gear position is shifted to each of the other gear positions (i) is calculated based on Expression (1) described above. Next, in S4 corresponding to the gear selection section 108, the motor rotation speed Nmg of the motor MG in the case where the gear position is shifted to each of the other gear positions (i) is calculated based on Expression (2) described above. In S5 corresponding to the gear selection section 108, the control mode of the inverter 40 in the case where the gear position is shifted to each of the other gear positions (i) is determined by referring to the control mode map of FIG. 4 based on the motor torque Tmg and the motor rotation speed Nmg in the case where the gear position is shifted to each of the other gear positions (i) calculated in S3 and S4. In S6 corresponding to the gear selection section 108, from among the gear positions (i) each of which the control mode of the inverter 40 is determined, the gear position that sets the control mode to the sinusoidal wave mode is selected. In S7 corresponding to the gear selection section 108, from among the gear positions selected in S6 that set the control mode to the sinusoidal wave mode, the gear position that requires the smallest number of times of gear shifting from the current gear position (the smallest number of times of gear change) is selected. Subsequently, in S8 corresponding to the stepped transmission control section 102, the gear shifting control to the selected gear position is executed. With this, since the control mode of the inverter 40 is set to the sinusoidal wave mode, the torque responsiveness of the motor MG when the vibration damping control by the hybrid control section 104 is executed thereafter is enhanced. Accordingly, the vibration is effectively reduced by the vibration damping control, and the drivability is improved.

As described above, according to the present embodiment, in the case where the vibration damping control is performed, the gear position is shifted to the gear position that sets the control mode of the inverter 40 to the sinusoidal wave mode that provides excellent controllability (responsiveness) of the motor torque Tmg. Consequently, since the controllability of the motor torque Tmg when the vibration damping control is performed is enhanced, the vehicle shock is reduced and the drivability is improved.

In addition, according to the present embodiment, at the time of the engine starting up when the torque fluctuation is increased, the control mode of the inverter 40 is set to the sinusoidal wave mode that provides excellent controllability (responsiveness) of the motor torque Tmg. Consequently, since the controllability of the motor torque Tmg at the time of the engine start is improved, the accuracy in the vibration damping control during the engine starting up is enhanced, the vehicle shock is reduced, and the drivability is improved.

Further, according to the present embodiment, in the case where there is a plurality of the gear positions that set the control mode to the sinusoidal wave mode, the gear that requires the smallest number of times of gear shifting from the current gear position is selected. With this arrangement, the number of times of gear shifting is minimized, and hence the shock during the gear shifting is reduced as compared with a case where the gear position is shifted to the gear position away from the current gear position in terms of the number of times of the gear shifting.

Moreover, according to the present embodiment, since the gear position is shifted to the gear position that maximizes fuel efficiency when the vibration damping control is ended, the fuel efficiency after the vibration damping control is improved.

Next, another embodiment of the invention will be described. Note that, in the following description, portions common to the above-described embodiment are denoted with the same reference numerals and the description thereof will be omitted.

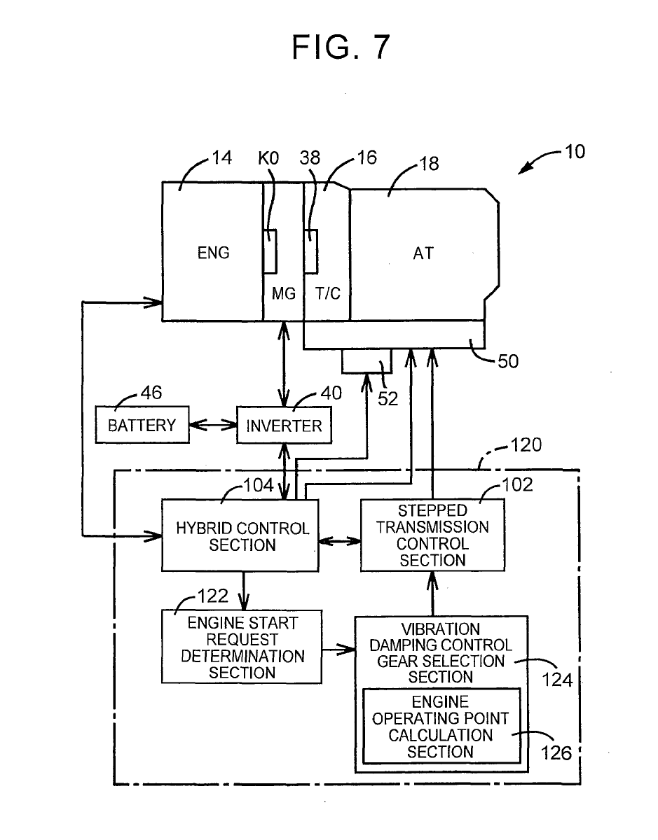

FIG. 7 is a functional block diagram for explaining the principal portion of the control operation of an electronic control device 120 as another embodiment of the invention. When the functional block diagram of the present embodiment is compared with the above-described functional block diagram of FIG. 2, the functional block diagram of the present embodiment is different from that of FIG. 2 in that an engine starting up request determination section 122 (engine starting up request determination means) is provided, and in the specific control details of a vibration damping control gear selection section 124 (hereinafter referred to as a gear selection section 124). Hereinbelow, a description will be given of each of the engine starting up request determination section 122 and the gear selection section 124 that are different from the above-described embodiment.

The engine starting up request determination section 122 determines whether or not a switching request from the EV running to the engine running (the HV running), i.e., a request for starting up the engine 14 is outputted. The engine starting up request determination section 122 determines the engine starting up based on, e.g., whether or not an engine starting up command is outputted from the hybrid control section 104.

When the starting up of the engine 14 is determined, the operation of the gear selection section 124 is executed. Herein, the gear selection section 124 includes, as its function, an engine operating point calculation section 126 (engine operating point calculation means) that calculates the operating point of the engine in a case where the gear position is shifted to each gear position (i) when the gear position is selected.

First, the engine operating point calculation section 126 calculates a requested value We of the engine output (an engine output requested value We) based on the requested driving force, a charge-discharge demand of the battery 46, the vehicle speed V and the like. Subsequently, the engine operating point calculation section 126 calculates the engine operating point (an engine rotation speed Nei (i=1, 2 . . . ), an engine torque Tei (i=1, 2 . . . )) in the case where the gear position is shifted to each gear position (i) based on the following Expressions (3) and (4). Note that the numerical subscript i in Expressions (3) and (4) denotes the number of the gear position. In addition, in Expressions (3) and (4), V denotes the vehicle speed, r denotes the tire radius, γdef denotes the differential ratio, and γi denotes the speed ratio corresponding to each gear position (i). Based on Expression (3), an engine rotation speed Ne1 at the time of the first gear position 1st is represented by V/(2π×r)×γdef×γ1, an engine rotation speed Ne2 at the time of the second gear position 2nd is represented by V/(2π×r)×γdef×γ2, and engine rotation speeds at the time of the third and subsequent gear positions are also calculated based on Expression (3). In addition, based on Expression (4), an engine torque Te1 at the time of the first gear position 1st is represented by We/Ne1, an engine torque Te2 at the time of the second gear position 2nd is represented by We/Ne2, and engine torques at the time of the third and subsequent gear positions are also calculated based on Expression (4).

Nei=V/(2π×r)×γdef×γi (3)

Tei=We/Nei (4)

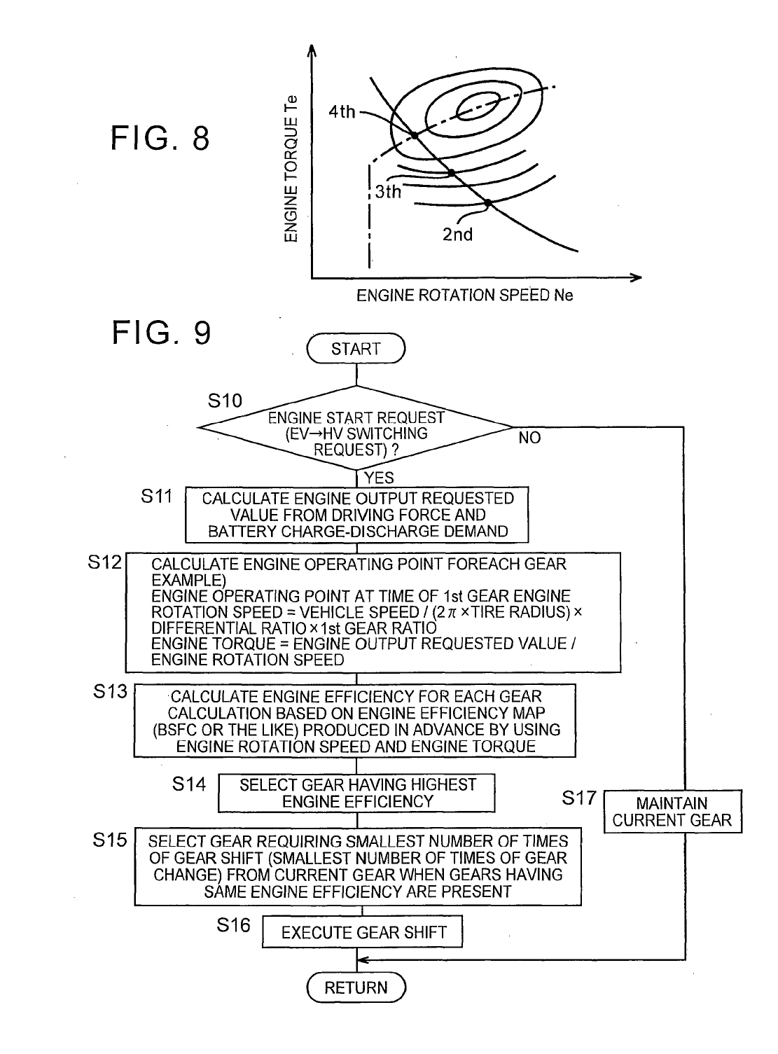

The gear selection section 124 calculates an engine efficiency ηi in each gear position (i) based on a predetermined engine efficiency map shown in FIG. 8 from the calculated engine operating point of each gear position (i). With regard to FIG. 8, the horizontal axis indicates the engine rotation speed Ne, and the vertical axis indicates the engine torque Te. In addition, oblongs shown in FIG. 8 indicate contour lines of the engine efficiency η. As the oblong is smaller, the efficiency of the engine 14 is higher. Further, a one-dot chain line indicates an optimum fuel efficiency curve of the engine 14. When the engine operating point moves on the one-dot chain line, the fuel efficiency is optimized. In a case where the engine output requested value We is constant, as shown in FIG. 8, the operating point of the engine 14 moves on an equal power line. Herein, in FIG. 8, the engine efficiency η is minimized during running in the second gear position 2nd. In the third gear position 3rd, the engine efficiency η is higher than that in the second gear position 2nd. In the fourth gear position 4th, the engine efficiency η is maximized. In this case, the gear selection section 124 selects the fourth gear position 4th having the highest engine efficiency Note that, in a case where the engine efficiency has the same value in a plurality of gear positions, the gear selection section 124 selects the gear position that requires the smallest number of times of gear shifting (the smallest number of time of gear change) from the current gear position.

FIG. 9 is a flowchart for explaining the principal portion of the control operation of the electronic control device 120, i.e., the control operation capable of improving the fuel efficiency when the running is switched from the EV running to the engine running, and the control operation is repeatedly executed at an extremely short cycle time of, e.g., about several millisecond to several tens millisecond.

First, in step S10 (hereinafter “step” will be omitted) corresponding to the engine starting up request determination section 122, it is determined whether or not switching from the EV running to the engine running, i.e., a request for starting up the engine 14 is outputted. In a case where S10 is negative, in S17 corresponding to the stepped transmission control section 102, the current gear position is maintained. In a case where S10 is affirmative, in S11 corresponding to the hybrid control section 104, the engine output requested value We is calculated based on the driving force and the charge-discharge demand of the battery 46. Next, in S12 corresponding to the engine operating point calculation section, the engine operating point (the engine rotation speed Nei, the engine torque Tei) for each gear position (i) is calculated. In S13 corresponding to the gear selection section 124, the engine efficiency ηi for each gear position (i) is calculated from the engine operating point for each gear position (i) calculated in S12 by referring to the engine efficiency map shown in FIG. 8. Subsequently, in S14 corresponding to the gear selection section 124, the gear position having the highest engine efficiency η among the engine efficiencies ηi calculated in S13 is selected. In addition, in S15 corresponding to the gear selection section 124, in the case where another gear position has the same engine efficiency η, the gear position that requires the smallest number of times of gear shifting (the smallest number of times of gear change) from the current gear position is selected. Subsequently, in S16 corresponding to the stepped transmission control section 102, the gear position shift to the selected gear position (i) is executed. Thereafter, the engine starting up process by the hybrid control section 104 is executed. When the engine starting up is completed, the operating point of the engine 14 corresponds to the operating point having a high engine efficiency η, and hence the fuel efficiency is improved.

As described above, according to the present embodiment, by selecting the gear position of the automatic transmission 18 such that the engine 14 is driven at the operating point having the high engine efficiency η after the engine starting up, it is possible to improve the fuel efficiency after the engine starting up.

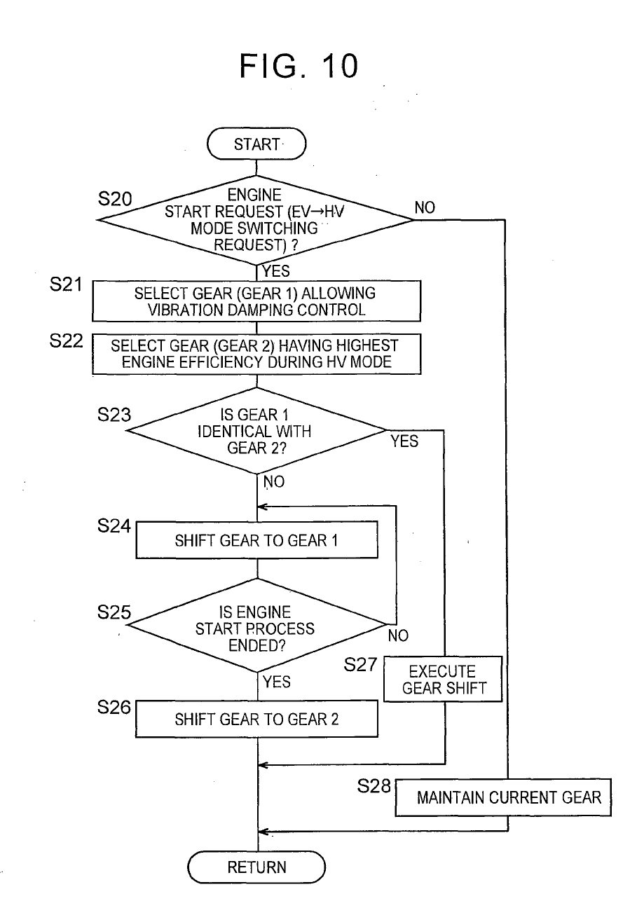

FIG. 10 is a flowchart for explaining still another embodiment of the invention. Specifically, FIG. 10 is a flowchart for explaining a control operation capable of improving the fuel efficiency after the engine starting up while suppressing the vibration during the engine starting up when the running is switched from the EV running to the engine running.

First, in S20, it is determined whether or not the request for switching from the EV running to the engine running, i.e., the request for starting up the engine 14 is outputted. In a case where S20 is negative, the current gear position is maintained in S28. In a case where S20 is affirmative, in S21, first gear position GEAR1 of the automatic transmission 18 that allows the vibration damping control is selected. Note that the specific control details in S21 are the same as those of the gear selection section 108 of the above-described first, embodiment, and hence the description thereof will be omitted. Next, in S22, second gear position GEAR2 that maximizes the engine efficiency during the HV running mode (during the engine running) is selected. Note that the specific control details in S22 are the same as those of the gear selection section 124 of the above-described second embodiment, and hence the description thereof will be omitted. In S23, it is determined whether or not first gear position GEAR1 selected in S21 is identical with second gear position GEAR2 selected in S22. In a case where S23 is affirmative. In S27, the gear shifting to the identical gear position is executed. In a case where S23 is negative. In S24, the gear shifting to the first gear position GEAR1 selected in S21 is executed. When the gear position is shifted to the first gear position GEAR1, the control mode of the inverter 40 is set to the sinusoidal wave mode, and hence the vibration damping control can be executed. Subsequently, when the gear shift to the first gear position GEAR1 is completed, the vibration damping control is executed concurrently with the engine starting up, and hence the vibration is reduced. In S25, it is determined whether or not the engine starting up is ended. In a case where S25 is negative, the vibration damping control is continuously executed. In a case where S25 is affirmative, the gear shift to the second gear position GEAR2 selected in S22 is executed. Consequently, when the starting up of the engine 14 is ended, the gear position is shifted such that the engine 14 is driven at the operating point that maximizes the engine efficiency η, and hence the fuel efficiency is improved.

As described above, according to the present embodiment, since the gear position is shifted to the gear position that allows the vibration damping control at the time of the engine starting up, and the gear position is shifted to the gear position that increases the engine efficiency η when the vibration damping control during the engine starting up is ended, it is possible to achieve a reduction in shock by the vibration damping control and an improvement in fuel efficiency after the engine starting up.

The embodiments of the invention have been described in detail based on the drawing thus far, and the invention can also be applied in other aspects.

For example, although the embodiments described above are independent of each other, they may also be combined appropriately and implemented in a range without contradiction.

In addition, in the embodiments described above, as the aspect in which the vibration damping control is executed, although the time of the engine starting up and the time of occurrence of the roll surge of the tire are shown as examples, the vibration damping control is not limited thereto. For example, even in a case where the tire repeats slip and grip on a winding road or icy road, a torque inputted to a drive system is caused to fluctuate, and the vibration is thereby caused, the vibration damping control is executed. Note that, since the vibration damping control execution determination section 106 determines whether or not the vibration damping control is executed based on a change in the rotation speed of the motor MG, the execution of the vibration damping control is determined even in other aspects, and the operation of the gear selection section 108 is appropriately executed.

In addition, in the embodiments described above, although the control mode of the inverter 40 includes three types of the sinusoidal wave mode, the overmodulation mode, and the rectangular wave mode, the control mode thereof may include, e.g., two types of the sinusoidal wave mode and the rectangular wave mode.

Further, in the embodiments described above, although the gear position of the automatic transmission 18 is shifted to the gear position that allows the vibration damping control at the time of the engine starting up, and the gear position is shifted to the gear position that increases the engine efficiency η when the engine starting up is ended, the timing of the gear shifting is not necessarily limited to the time of the engine starting up. For example, the gear position can be shifted to the gear position that allows the vibration damping control in a case where the vibration damping control is required when the engine is driven, and the gear position can be shifted to the gear position that increases the engine efficiency η when the vibration damping control is ended.

Furthermore, although the automatic transmission 18 in the embodiments described above is a stepped automatic transmission, the specific structure and the number of the gear positions of the transmission are not particularly limited.

Additionally, in the individual flowcharts of the embodiments described above, the order of steps may be appropriately changed in a range without contradiction. For example, in the flowchart of FIG. 6, the order of S3 and S4 can be reversed, and S4 and S3 can be executed in this order.

In addition, in the embodiments described above, although the starting up of the engine 14 is determined based on whether or not the command for starting up the engine 14 is outputted from the hybrid control section 104, the starting up of the engine 14 may also be determined by other means such as a determination based on a pre-set running mode map that defines the EV running and the engine running.

Note that each of the embodiments described above is one exemplary embodiment only, and the invention can be embodied with various modifications and improvements based on knowledge of those skilled in the art.

1. A control device for a vehicle, the control device comprising:
a motor;
a transmission provided in a path that transmits drive power between the motor and a driving wheel;
an inverter configured to drive the motor;
a controller configured to control the inverter by using a plurality of control modes including a sinusoidal wave mode to drive the motor, the controller configured to select the control mode in accordance with a gear position of the transmission, and the controller configured to select the gear position by which the sinusoidal wave mode is selected when the motor controlled by the controller suppresses a vibration of the vehicle.

2. A control device for a vehicle, the control device comprising:
a motor;
an internal combustion engine;
a transmission provided in a path that transmits drive power between the motor and a driving wheel;
an inverter configured to drive the motor;
a controller configured to control the inverter by using a plurality of control modes including a sinusoidal wave mode to drive the motor, the controller configured to select the control mode in accordance with a gear position of the transmission, and the controller configured to select the gear position by which the sinusoidal wave mode is selected when the internal combustion engine is starting up.

3. The control device according to claim 1, wherein the controller is configured to select the gear position such that a target gear position requires a smallest number of gear shifting from a current gear position in case there are at least two gear positions by which sinusoidal wave mode is selected.

4. The control device according to claim 2, wherein
the controller is configured to select the gear position that maximizes efficiency of the internal combustion engine after the starting up of the internal combustion engine is ended.
